(19) United States
(12) Patent Application Publication
(10) Pub. No.: US 2020/0182320 A1
(43) Pub. Date: Jun. 11, 2020

(54) BRAKE PISTON HAVING A NON-CIRCULAR END FACE FOR A DISC BRAKE ASSEMBLY WITH AN ELECTRIC PARKING BRAKE

(71) Applicant: ZF Active Safety US Inc., Livonia, MI (US)

(72) Inventors: Manuel Barbosa, Novi, MI (US); Christopher McCormick, Novi, MI (US)

(73) Assignee: ZF Active Safety US Inc., Livonia, MI (US)

(21) Appl. No.: 16/697,952

(22) Filed: Nov. 27, 2019

Related U.S. Application Data
(60) Provisional application No. 62/776,154, filed on Dec. 6, 2018.

(51) Int. Cl. F16D 65/18; F16J 1/00

(52) U.S. Cl. CPC F16D 65/18; F16D 2125/06; F16J 1/00

(57) ABSTRACT

A brake piston for use in a disc brake assembly having an external surface disposed along a longitudinal axis; and a non-circular end face being disposed perpendicular to the external surface and the longitudinal axis. The non-circular end-face and the external surface define a cavity and the non-circular end face is configured to engage with a brake disc when the disc brake assembly is actuated.

### CROSS-REFERENCE TO RELATED APPLICATION

This application claims priority to U.S. Provisional Patent Application No. 62/776,154, filed Dec. 7, 2018, the disclosure of which is incorporated herein by reference in its entirety.

### TECHNICAL FIELD

This invention relates in general to vehicle disc brake assemblies and in particular to an improved brake piston for use with a parking brake function of such a disc brake assembly.

### BACKGROUND

A typical disc brake assembly for a vehicle includes a brake disc which is secured to a wheel of the vehicle for rotation therewith and non-rotating brake linings that are operable between non-braking and braking positions. Each of the brake linings is supported on a brake shoe. In the non-braking position, the brake linings do not slow rotation of the brake disc and vehicle wheel. In the braking position, the brake linings are in frictional engagement with the brake disc to slow rotation of the brake disc and vehicle wheel. The disc brake assembly further includes a brake piston and a sliding brake caliper. The brake piston is a cylindrical body with a constant diameter and a circular end face. The circular end face applies pressure to the brake linings. The cylindrical body is used for ease of manufacturing.

The brake linings are moved into the braking position by the brake piston and the sliding brake caliper. For example, hydraulic pressure may linearly actuate the brake piston to displace the brake linings to frictionally engage the brake disc. This provides service braking. Typically, the brake piston displaces an inboard brake lining directly and an outboard brake lining via the brake caliper.

The disc brake assembly may also be used to provide a parking brake function. The disc brake assembly provides the parking brake function by first using the pressure to move the brake linings into the braking position and then using an electric parking brake (EPB) to clamp or otherwise support the brake piston in the braking position. An actuator of the EPB may comprise a rotationally restrained spindle nut threaded onto a spindle driven by an electric motor. As the spindle is rotationally driven, the spindle nut axially translates to clamp the brake piston on the brake linings in the braking position.

Generally, as more brake pistons are provided for the single disc brake assembly, a brake force produced by the disc brake assembly increases. To produce a required brake force for some vehicles, such as pickup trucks, twin—i.e., two—brake pistons are commonly provided. The twin brake pistons are also cylindrical bodies with circular end faces. When the disc brake assembly with twin brake pistons provides the parking brake function, the EPB clamps both of the twin brake pistons. To clamp both of the twin brake pistons, the EPB requires either a separate actuator for each of the twin brake pistons, for a total of two actuators, or a single actuator clamping both of the twin brake pistons through additional gearing such as a differential. Either the second actuator or the additional gearing make the EPB for the twin brake pistons more expensive.

Alternatively to providing multiple brake pistons—e.g., the twin brake pistons—the brake force produced by the disc brake assembly may be increased by increasing a constant diameter of a single brake piston. The single brake piston having the increased diameter maintains the easily manufactured cylindrical body and circular end face of the previously described brake pistons. When the disc brake assembly with the single brake piston having the increased diameter provides the parking brake function, neither the second actuator or the additional gearing are required. However, the single brake piston having the increased diameter requires additional packaging space that may not be readily available. For example, the additional packaging space would not be available on a vehicle with a traditional—i.e., non-EPB—parking brake. As a result, the EPB with the single brake piston having the increased diameter would not be readily interchangeable with the traditional parking brake. Additionally, the increased diameter makes packaging of the EPB's spindle nut and spindle into the single piston more challenging. Thus, it would be desirable to have a disc brake assembly with an EPB that produces a greater brake force without the increased cost of the twin brake pistons or the required additional packaging space for the single brake piston having the increased diameter.

### SUMMARY

This invention relates to a brake piston having a non-circular end face for use with a parking brake function of a disc brake assembly.

According to one aspect of the invention, a brake piston of a disc brake assembly has a non-circular end face. The non-circular end face has a variable, non-constant radius. The non-circular end face may be an oval or elliptical shape. The variable radius is from every point of the non-circular end face to a perimeter of the non-circular end face.

According to another aspect of the invention, a brake piston of a disc brake assembly has a non-circular end face, wherein the non-circular end face has perpendicular first and second dimensions and the first dimension is greater than the second dimension. The first and second dimensions intersect at midpoints of each other. A ratio of the first and second dimensions is other than one.

According to another aspect of the invention, a brake piston of a disc brake assembly has a non-circular end face and there is a clearance between the non-circular end face and a perimeter of a brake shoe, wherein the clearance is on all sides of the non-circular end face. The non-circular end face does not extend beyond the brake shoe.

An advantage of an embodiment is a disc brake assembly with an electric parking brake that produces a greater brake force without an increased cost of twin brake pistons or requiring additional packaging space for a single brake piston having an increased diameter. Other advantages of this invention will become apparent to those skilled in the art from the following detailed description of the preferred embodiments, when read in light of the accompanying drawings.

### BRIEF DESCRIPTION OF DRAWINGS

FIG. 1 is a front elevation of a disc brake assembly having a first embodiment of a brake piston in accordance with the present invention.

FIG. 2 is a top elevation of the disc brake assembly of FIG. 1.

FIG. 3 is a sectional perspective view of the disc brake assembly of FIG. 1.

FIG. 4 is a section view taken along line 4-4 of FIG. 3.

FIG. 5 is a perspective view of the brake piston of FIG. 1.

FIG. 6 is a front elevation of the brake piston of FIG. 1.

FIG. 7 is a rear elevation of the brake piston of FIG. 1.

FIG. 8 is a schematic view comparing the front elevation of the brake piston of FIG. 1 to front elevations of prior art brake pistons.

FIG. 9 is a schematic view of a first method for manufacturing the brake piston of FIG. 1.

FIG. 10 is a schematic view of a second method for manufacturing the brake piston of FIG. 1.

FIG. 11 is a schematic view of a first method for manufacturing a brake caliper of the disc brake assembly of FIG. 1.

FIG. 12 is a schematic view of a second method for manufacturing the brake caliper of the disc brake assembly of FIG. 1.

FIG. 13 is a first perspective view of an alternate brake caliper for the disc brake assembly of FIG. 1.

FIG. 14 is a second perspective view of the alternate brake caliper of FIG. 13.

FIG. 15 is a perspective view of a main body portion of the alternate brake caliper of FIG. 13.

FIG. 16 is a perspective view of a bridge portion of the alternate brake caliper of FIG. 13.

FIG. 17 is a section view taken along line 17-17 of FIG. 13.

FIG. 18 is a front elevation of a second embodiment of a brake piston in accordance with the present invention.

FIG. 19 is a front elevation of a third embodiment of a brake piston in accordance with the present invention.

FIG. 20 is a front elevation of a fourth embodiment of a brake piston in accordance with the present invention.

FIG. 21 is a front elevation of a fifth embodiment of a brake piston in accordance with the present invention.

FIG. 22 is a front elevation of a sixth embodiment of a brake piston in accordance with the present invention.

FIG. 23 is a front elevation of a seventh embodiment of a brake piston in accordance with the present invention.

FIG. 24 is a front elevation of an eighth embodiment of a brake piston in accordance with the present invention.

FIG. 25 is a front elevation of a ninth embodiment of a brake piston in accordance with the present invention.

FIG. 26 is a front elevation of a tenth embodiment of a brake piston in accordance with the present invention.

FIG. 27 is a front elevation of an eleventh embodiment of a brake piston in accordance with the present invention.

### DETAILED DESCRIPTION

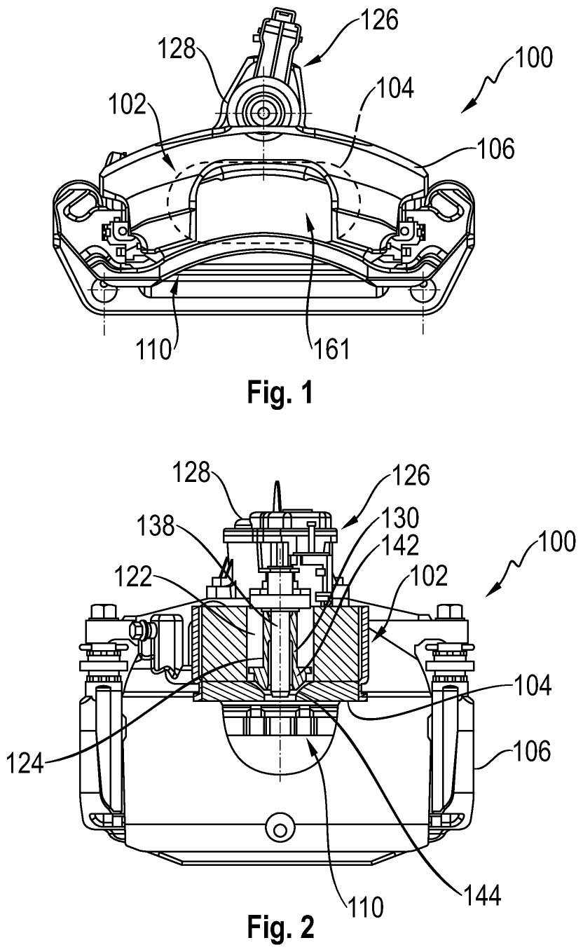

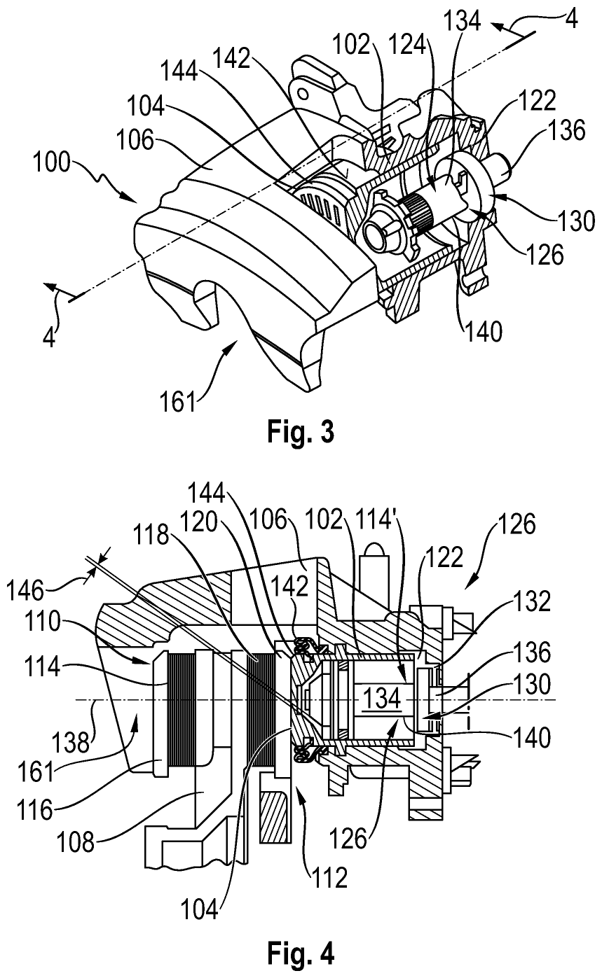

Referring now to FIGS. 1-4, there is illustrated a disc brake assembly, indicated generally at 100, having a brake piston, indicated generally at 102, with a planar, non-circular end face 104 (shown by dashed lines in FIG. 1). The general structure and operation of the disc brake assembly 100 is well known in the prior art. For example, the disc brake assembly 100 may be such as is disclosed by U.S. Pat. No. 8,844,683 to Sternal et al., U.S. Patent Application Publication No. 2017/0261053 to Schaefer et al., or U.S. Patent Publication No. 2018/0087589 to Gerber et al, the disclosures of all of which are hereby incorporated by reference in entirety herein.

The disc brake assembly 100 includes a sliding brake caliper 106. The brake caliper 106 is mounted in a floating manner by means of a brake carrier (not shown) in a manner known to those skilled in the art. The brake caliper 106 also spans a brake disc 108 that is coupled to a vehicle wheel 109 (shown in FIG. 17) in a rotationally fixed manner.

Provided in the brake caliper 106 are outboard and inboard brake shoes, indicated generally at 110 and 112, respectively. The outboard brake shoe 110 has an outboard brake lining 114 supported on an outboard backing plate 116. Similarly, the inboard brake shoe 112 has an inboard brake lining 118 supported on an inboard backing plate 120. The brake caliper 106 bears on the outboard backing plate 116 and the brake piston 102 bears on the inboard backing plate 120. The outboard and inboard brake linings 114 and 118, respectively, face towards each other and, in a release position (not shown), are disposed with a small air clearance on both sides of the brake disc 108, such that no significant residual drag moments occur on the brake disc 108. The inboard backing plate 120 is disposed between the inboard brake lining 118 and the brake piston 102 such that the inboard brake lining 118 and the brake piston 102 move jointly.

The brake piston 102 is mounted in a movable manner in a cavity 122 in the brake caliper 106. The cavity 122 corresponds in shape to the brake piston 102. In addition, it can be seen that the brake piston 102 is realized so as to be hollow. Accommodated in the brake piston 102 is a rotationally restrained spindle nut, indicated generally at 124, of an electric parking brake (EPB), indicated generally at 126. The EPB 126 preferably includes a drive assembly 128 having a suitable power source and transmission assembly known to those skilled in the art. As a non-limiting example, the power source may be an electric motor.

A spindle, indicated generally at 130, is operatively connected to the drive assembly 128, supported via an axial bearing 132, and accommodated in a threaded manner in a threaded receiver 134 of the spindle nut 124. An output shaft 136 of the drive assembly 128 rotationally drives the spindle 130. This results in movement of the spindle nut 124 along a longitudinal axis 138 because the spindle nut 124 is rotationally restrained. An external surface 140 of the spindle nut 124 is preferably cylindrical. The outboard and inboard brake shoes 110 and 112, respectively, as well as the brake piston 102, are also displaceable along the longitudinal axis 138.

The spindle nut 124 has a conical portion 142 which can be brought into bearing contact with a complementary conical inner portion 144 of the brake piston 102. In the release position, there is a clearance 146 between the conical portion 142 and the conical inner portion 144. The construction, shape, configuration, and/or make-up of the conical portion 142 and the complementary conical inner portion 144 may be other than as illustrated and described, if so desired. For example, the conical portion 142 and the conical inner portion 144 may have other, non-conical, complimentary shapes.

When service braking is desired for a vehicle having the disc brake assembly 100, the disc brake assembly 100 is hydraulically actuated. For example, the disc brake assembly 100 may be hydraulically actuated by a driver via a brake pedal or via a drive assistance system. When the disc brake assembly 100 is hydraulically actuated, hydraulic fluid is pressurized (by a suitable means known to those skilled in the art) in the cavity 122 such that the brake piston 102 is displaced leftward in FIG. 4 along the longitudinal axis 138. As a consequence, and as is known to those skilled in the art, the inboard brake lining 118 is pressed onto the brake disc 108 by the brake piston 102 (i.e., by the non-circular end face 104) and, at the same time, a corresponding displacement of the brake caliper 106 on an opposite side of the brake disc 108 causes the outboard brake lining 114 to be drawn against the opposite side of the brake disc 108. As a result of the application of the pressurized hydraulic fluid to the cavity 122, the brake piston 102 has been displaced leftward in FIG. 2, along the longitudinal axis 138 towards the brake disc 108 and into a braking position. The spindle nut 124 remains unactuated, and therefore remains at an initial axial position in FIG. 2.

For activating a parking brake function of the disc brake assembly 100, in a manner similar to service braking, the brake piston 102 is first put into the braking position through application of hydraulic pressure. Actuation of the EPB 126 then causes the drive assembly 128 to displace the spindle nut 124 towards the brake disc 108 until the clearance 146 has been used up and the conical portion 142 bears on the corresponding conical inner portion 144 inside the brake piston 102. As a result, the brake piston 102 is axially clamped, via the spindle nut 124 and the axial bearing 132, on the housing of the brake caliper 106 in a parking brake state.

Once the brake piston 102 is axially clamped, the hydraulic pressure in the cavity 122 can be removed. The parking brake state is maintained because of the position of the spindle nut 124 and because of self-arresting (for example, by a self-arresting transmission between the spindle 130 and the threaded receiver 134). The outboard and inboard brake linings 114 and 118, respectively, pressing against the brake disc 108 are clamped via the spindle nut 124.

When the parking brake state is to be released, pressurized hydraulic fluid is again introduced into the cavity 122. As a result, the brake piston 102 is displaced slightly leftward, along the longitudinal axis 138, towards the brake disc 108 such that the spindle nut 124 is relieved of axial load. Through control of the EPB 126, the spindle nut 124 can then be displaced back into the initial axial position illustrated in FIG. 4.

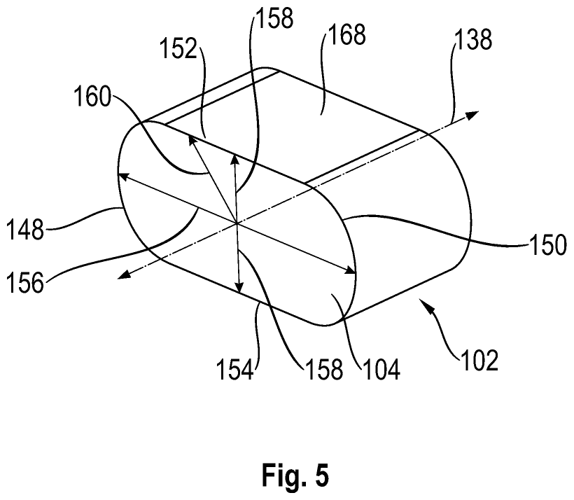

Referring now to FIG. 5, the brake piston 102 is illustrated in detail. As can be seen, the brake piston 102 does not have a circular end face. More specifically, the non-circular end face 104 of the brake piston 102 does not have a constant diameter or radius. Thus, the end face 104 is defined herein as having a non-circular shape.

The non-circular end face 104 has first and second rounded portions 148 and 150, respectively. As illustrated, the first and second rounded portions 148 and 150, respectively, are 180°. Alternatively, one or both of the first and second rounded portions 148 and 150, respectively, may be other than as illustrated.

Interspaced between the first and second rounded portions 148 and 150, respectively, are first and second linear portions 152 and 154, respectively. As illustrated, the first and second linear portions 152 and 154, respectively, are parallel. Alternatively, the first and second linear portions 152 and 154, respectively, may be other than parallel.

The brake piston 102 extends along the longitudinal axis 138. The non-circular end face 104 is perpendicular to the longitudinal axis 138. Preferably, the longitudinal axis 138 passes through a centroid of the non-circular end face 104. As illustrated, the brake piston 102 has a constant cross section—i.e., the non-circular end face 104—along the longitudinal axis 138. Alternatively, the brake piston 102 may have other than a constant cross section along the longitudinal axis 138. As a non-limiting example, the brake piston 102 may have a body portion behind the non-circular end face 104 with a smaller cross section than the non-circular end face 104.

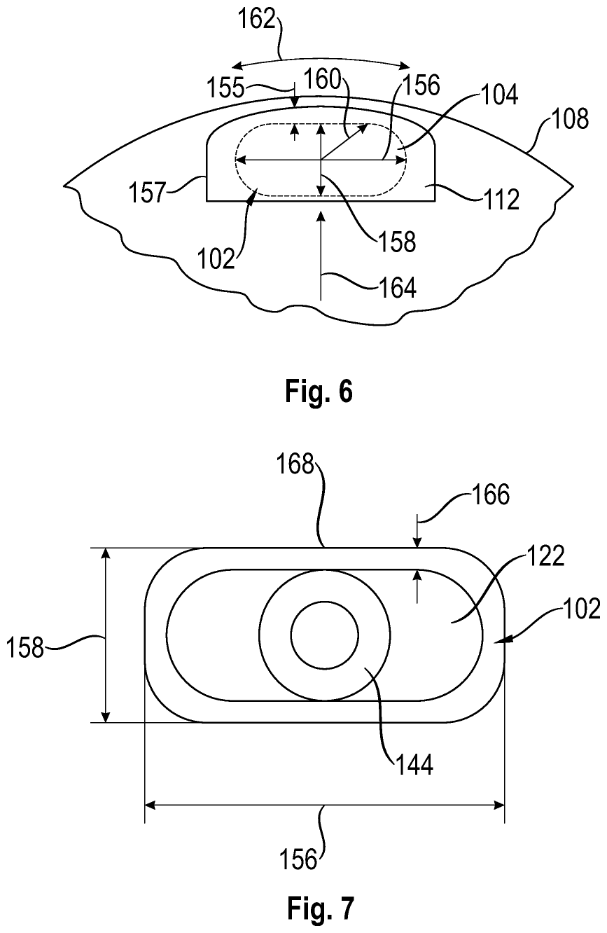

The non-circular end face 104 has first and second dimensions 156 and 158, respectively. The first dimension 156 is greater than the second dimension 158. A ratio of the first and second dimensions 156 and 158, respectively, is other than one. As illustrated, the first and second dimensions 156 and 158, respectively, are perpendicular and intersect at the longitudinal axis 138. Alternatively, the first and second dimensions 156 and 158, respectively, may intersect at midpoints of each other. As illustrated in FIG. 5, the first and second dimensions 156 and 158, respectively, intersect both at the longitudinal axis 138 and at midpoints of each other. While the first and second dimensions 156 and 158, respectively, are illustrated as perpendicular, the first and second dimensions 156 and 158, respectively, may alternatively be other than perpendicular. The first and second dimensions 156 and 158, respectively, will be discussed further with respect to FIG. 6.

Furthermore, the non-circular end face 104 has a variable—i.e., non-constant—radius 160 from the longitudinal axis 138 or centroid of the non-circular end face 104 to a perimeter of the non-circular end face 104, wherein the perimeter comprises the first and second rounded portions 148 and 150, respectively, and the first and second linear portions 152 and 154, respectively. The non-circular end face 104 has the variable radius 160 from every point of the non-circular end face to the perimeter of the non-circular end face 104. The variable radius 160 increases and decreases—i.e., is not constant—as it extends from the longitudinal axis 138 to the perimeter of the non-circular end face 104. The radius 160 varies because the non-circular end face 104 has the non-circular shape.

Referring now to FIG. 6, there is illustrated the non-circular end face 104 and the inboard brake shoe 112. As discussed, in the braking position, the non-circular end face 104 contacts the inboard brake shoe 112. An entirety of the non-circular end face 104 may be brought into contact with the inboard brake shoe 112. The non-circular end face 104 does not overhang, overlap, or otherwise extend beyond the inboard brake shoe 112. There is a clearance or margin 155 between the non-circular end face 104 and a perimeter 157 of the inboard brake shoe 112. The clearance 155 is on all sides of the non-circular end face 104 and the brake piston 102. Typically, the clearance 155 varies in value around the non-circular end face 104.

Also illustrated in FIG. 6 are a circumferential direction 162 and a radial direction 164. The brake disc 108 rotates in the circumferential direction 162. The radial direction 164 extends radially outward from a center of the vehicle wheel 109 (shown in FIG. 17). The non-circular end face 104 may be positioned relative to the brake disc 108 other than as illustrated in FIG. 6. As a non-limiting example, the non-circular end face 104 may be rotated in FIG. 6 relative to the brake disc 108.

The first dimension 156 is preferably tangential to the circumferential direction 162. The first dimension 156 preferably extends between maximum extents of the non-circular end face 104 that are tangential to the circumferential direction 162. The first dimension 156 is preferably defined tangential to the circumferential direction 162 so as to maximize a value of the first dimension 156.

The second dimension 158 is preferably parallel to the radial direction 164. The second dimension 158 preferably extends between minimum extents of the non-circular end face that are parallel to the radial direction 164. The second dimension 158 is preferably defined parallel to the radial direction 164 so as to minimize a value of the second dimension 158.

Referring now to FIG. 7, there is illustrated the brake piston 102 having a substantially constant wall thickness 166 between the cavity 122 and an external surface 168 of the brake piston 102 (also shown in FIG. 5).

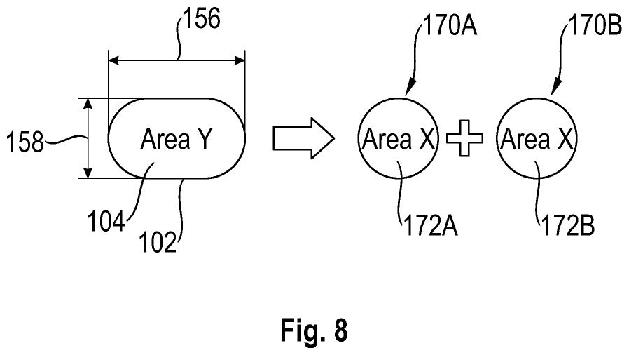

Referring now to FIG. 8, there is illustrated a comparison of the brake piston 102 with its non-circular end face 104 with first and second prior art brake pistons, indicated generally at 170A and 170B respectively. The first and second prior art brake pistons 170A and 1708, respectively, are commonly used together in a twin piston disc brake assembly (not shown). The first prior art brake piston 170A has a first prior art circular end face 172A and the second prior art brake piston 1708 has a second prior art circular end face 1728.

The non-circular end face 104 has an area “Y” and each of the first and second prior art circular end faces 172A and 1728, respectively, has an area “X.” The area “Y” is equal to two times the area “X”—i.e., the non-circular end face 104 has an area equal to a sum of the first and second prior art circular end faces 172A and 1728, respectively. As a result, the non-circular end face 104 has a cross sectional area equivalent to a cross sectional area of both the first and second prior art circular end faces 172A and 1728, respectively, working together—e.g., in the twin piston disc bake assembly. A maximum clamp force achieved by the brake piston 102 with the non-circular end face 104 is proportional to the area “Y” of the non-circular end face 104. Specifically, the maximum clamp force achieved by the brake piston 102 may be double a second maximum clamp force achieved by either the first or second prior art brake pistons 170A or 170B, respectively, acting alone.

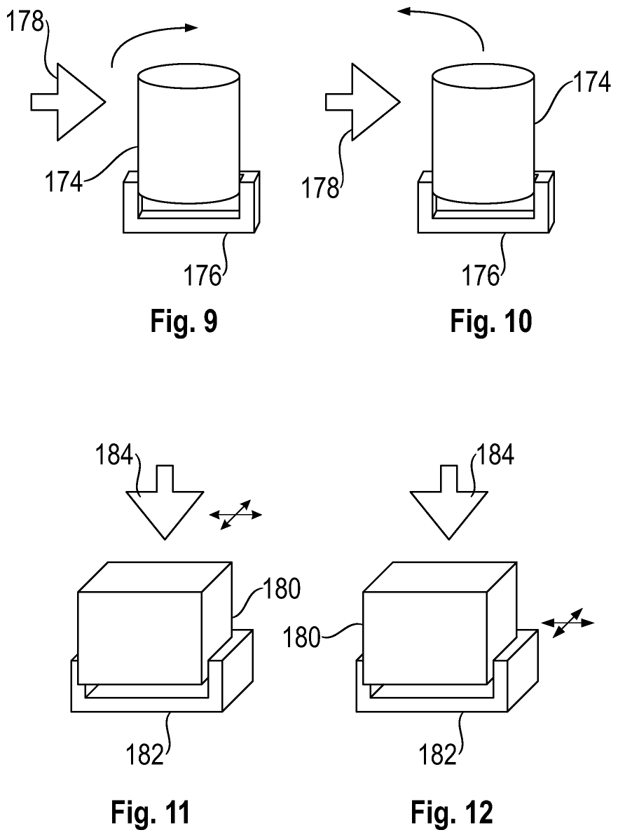

Referring now to FIG. 9, there is illustrated a first method for manufacturing the brake piston 102. In FIG. 8, a blank 174 for machining the brake piston 102 is held stationary by a clamp or other fixing device 176 while a tool 178 moves around the blank 174. The tool 178 machines the blank 174 into the brake piston 102. Preferably, the clamp 176 and the tool 178 together comprise a CNC (computerized numerical control) machine.

The brake piston 102 is preferably manufactured from steel to optimize the parking brake function of the disc brake assembly 100. Otherwise, the brake piston 102 may be manufactured from other materials such as aluminum or a phenolic material with a steel cap.

Referring now to FIG. 10, there is illustrated a second method for manufacturing the brake piston 102. In FIG. 10, the tool 178 remains stationary while the clamp 176 moves the blank 174 around the tool 178 for machining.

Referring now to FIG. 11, there is illustrated a first method for manufacturing the brake caliper 106. Initially, a rough casting 180 of the brake caliper 106 is cast. The rough casting 180 includes the cavity 122. As a non-limiting example, the cavity 122 may be rough cast into the rough casting 180 using a green sand casting technique. Then, the rough casting 180 is held stationary by a clamp or other fixing device 182 while a tool 184 moves around and inside the rough casting 180 to finish machine the cavity 122. Preferably, the clamp 182 and the tool 184 together comprise a CNC machine.

Referring now to FIG. 12, there is illustrated a second method for manufacturing the brake caliper 106. In FIG. 12, the tool 184 remains stationary while the clamp 182 moves the rough casting 180 around the tool 184 for machining.

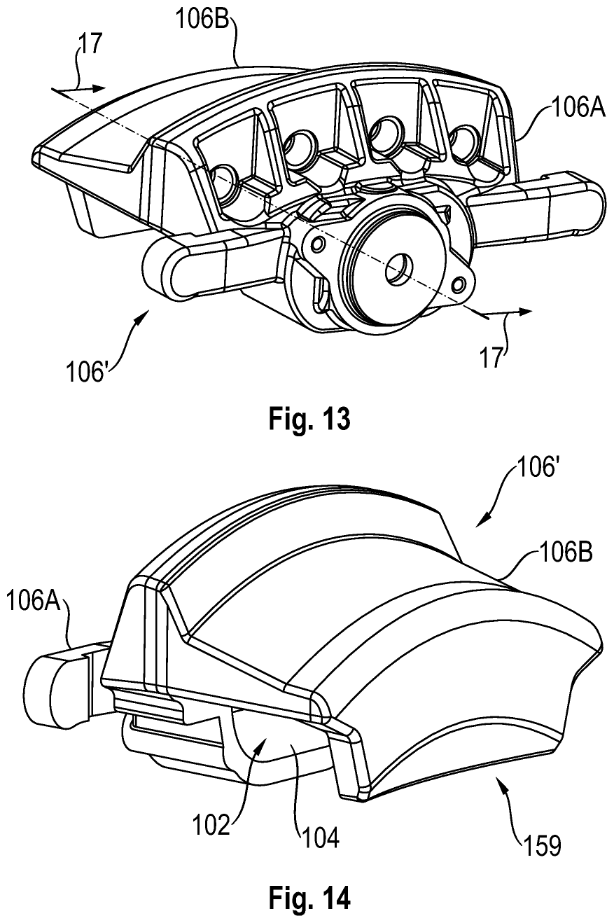

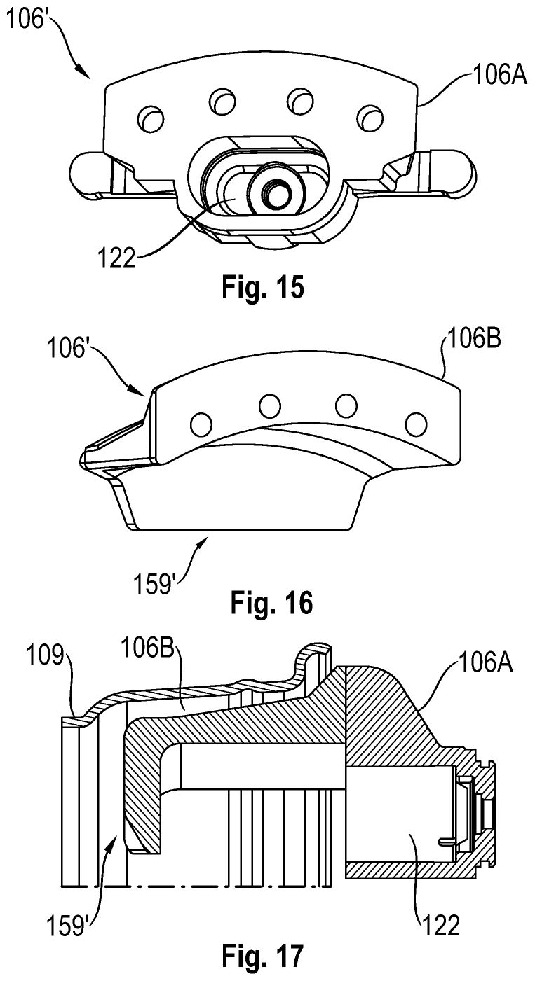

Referring now to FIGS. 13-17, there is illustrated an alternate brake caliper 106′ having separate main body and bridge portions 106A and 106B, respectively. The main body portion 106A and the bridge portion 106B are separately manufactured and then joined together to form the alternate brake caliper 106′. Preferably, the main body portion 106A and the bridge portion 106B are bolted together although other means of joining may be used. As non-limiting examples, the main body portion 106A may be manufactured from cast iron or aluminum and the bridge portion 106B may be manufactured from cast iron or forged steel. Preferably, the main body portion 106A is manufactured from aluminum and the bridge portion 106B is manufactured from forged steel. Forged steel has a higher modulus of elasticity which reduces deflection of the bridge portion 106B.

The bridge portion 106B includes a continuous outer pad support, indicated generally at 159. By being continuous, strength and stiffness of the outer pad support 159 is increased compared to the brake caliper 106. Unlike for the alternate brake caliper 106′, the outer pad support of the brake caliper 106 has an opening 161 (shown in FIGS. 1, 3, and 4). The continuous outer pad support 159 also improves durability of the outer pad support 159 in view of a typical high duty cycle for the electric parking brake function. The increased strength and stiffness of the continuous outer pad support 159 also improves pad taper and/or cupping wear for the outboard brake lining 114 (shown in FIG. 4) and better controls outer finger contact.

The alternate brake caliper 106′ improves access for finish machining of the cavity 122 during manufacturing of the alternate brake caliper 106′. The alternate brake caliper 106′ improves access for finish machining of the cavity 122 because the cavity 122 may be accessed for finish machining before the bridge portion 106B is attached to the main body portion 106A. Furthermore, the alternate brake caliper 106′ improves assembly of the disc brake assembly 100. The alternate brake caliper 106′ improves assembly of the disc brake assembly 100 because the cavity 122 may be accessed for installation of the brake piston 102 before the bridge portion 106B is attached to the main body portion 106A.

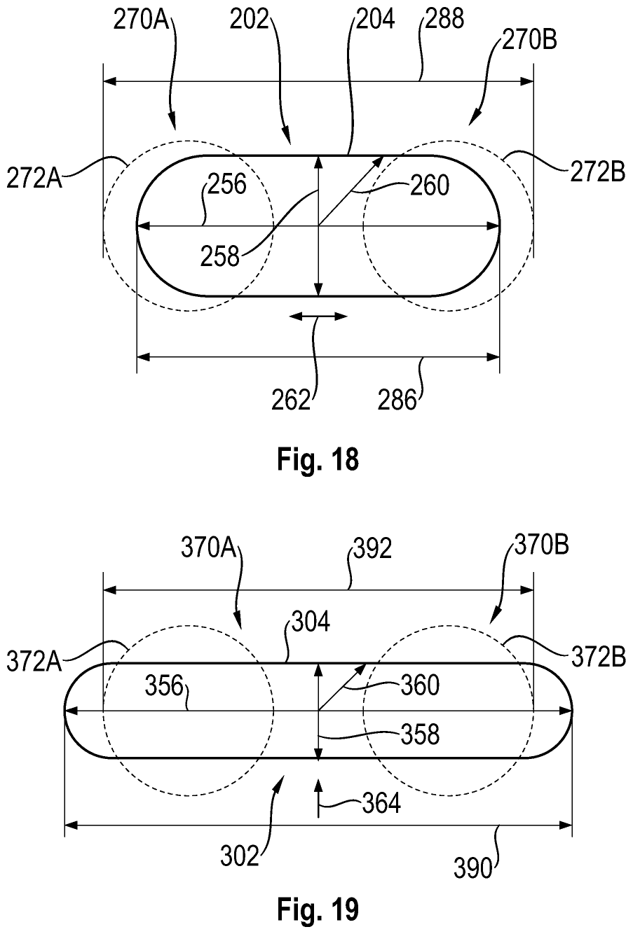

Referring now to FIG. 18, there is illustrated a brake piston, indicated generally at 202, and having a non-circular end face 204 in accordance with a second embodiment of the present invention. The brake piston 202 and the non-circular end face 204 are variations of the brake piston 102 and the non-circular end face 104 described with reference to FIGS. 1-12. As such, like reference numerals, increased by 100, designate corresponding parts in the drawings and detailed description thereof will be omitted, unless otherwise noted.

A first overall length 286 of the non-circular end face 204 is less than a second overall length 288 for first and second prior art circular end faces 272A and 272B, respectively. The second overall length 288 is measured between combined furthest extents of the first and second prior art circular end faces 272A and 272B, respectively. Preferably, the first and second overall lengths 286 and 288, respectively, are parallel. The non-circular end face 204 has an area equal to a sum of areas of each of the first and second prior art circular end faces 272A and 272B, respectively.

The first overall length 286 being less than the second overall length 288 allows a length (parallel to the first overall length 286) of an inboard brake shoe to be shorter than when the first and second prior art brake pistons 270A and 270B, respectively, are used. The brake piston 202 with the non-circular end face 204 may produce an equal braking force as a twin piston disc bake assembly having the first and second prior art circular end faces 272A and 272B, respectively, but require less space in a direction tangential to a circumferential direction 262.

Referring now to FIG. 19, there is illustrated a brake piston, indicated generally at 302, and having a non-circular end face 304 in accordance with a third embodiment of the present invention. The brake piston 302 and the non-circular end face 304 are variations of the brake piston 102 and the non-circular end face 104 described with reference to FIGS. 1-12. As such, like reference numerals, increased by 200, designate corresponding parts in the drawings and detailed description thereof will be omitted, unless otherwise noted.

A first overall length 390 of the non-circular end face 304 is greater than a second overall length 392 for first and second prior art circular end faces 372A and 372B, respectively. The second overall length 392 is measured between combined furthest extents of the first and second prior art circular end faces 372A and 372B, respectively. Preferably, the first and second overall lengths 390 and 392, respectively, are parallel. The non-circular end face 304 has an area equal to a sum of areas of each of the first and second prior art circular end faces 372A and 3728, respectively. The brake piston 302 with the non-circular end face 304 may produce an equal braking force as a twin piston disc bake assembly having the first and second prior art circular end faces 372A and 372B, respectively, but require less space in a radial direction 364.

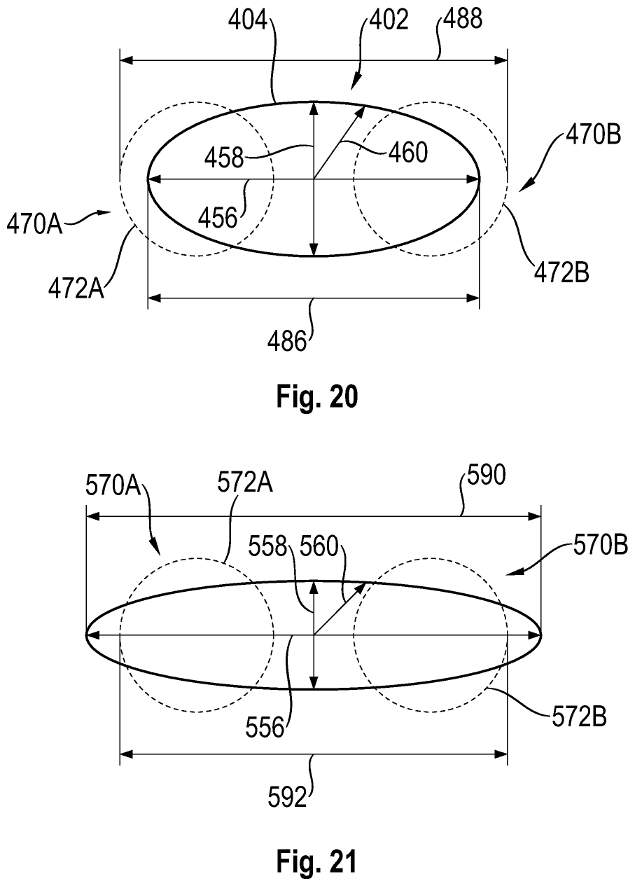

Referring now to FIG. 20, there is illustrated a brake piston, indicated generally at 402, and having a non-circular end face 404 in accordance with a fourth embodiment of the present invention. The brake piston 402 and the non-circular end face 404 are variations of the brake piston 202 and the non-circular end face 204 described with reference to FIG. 18. As such, like reference numerals, increased by 200, designate corresponding parts in the drawings and detailed description thereof will be omitted, unless otherwise noted. The end face 404 has an oval or elliptical shape without linear portions.

Referring now to FIG. 21, there is illustrated a brake piston, indicated generally at 502, and having a non-circular end face 504 in accordance with a fifth embodiment of the present invention. The brake piston 502 and the non-circular end face 504 are variations of the brake piston 302 and the non-circular end face 304 described with reference to FIG. 19. As such, like reference numerals, increased by 200, designate corresponding parts in the drawings and detailed description thereof will be omitted, unless otherwise noted. The end face 504 has an oval or elliptical shape without linear portions.

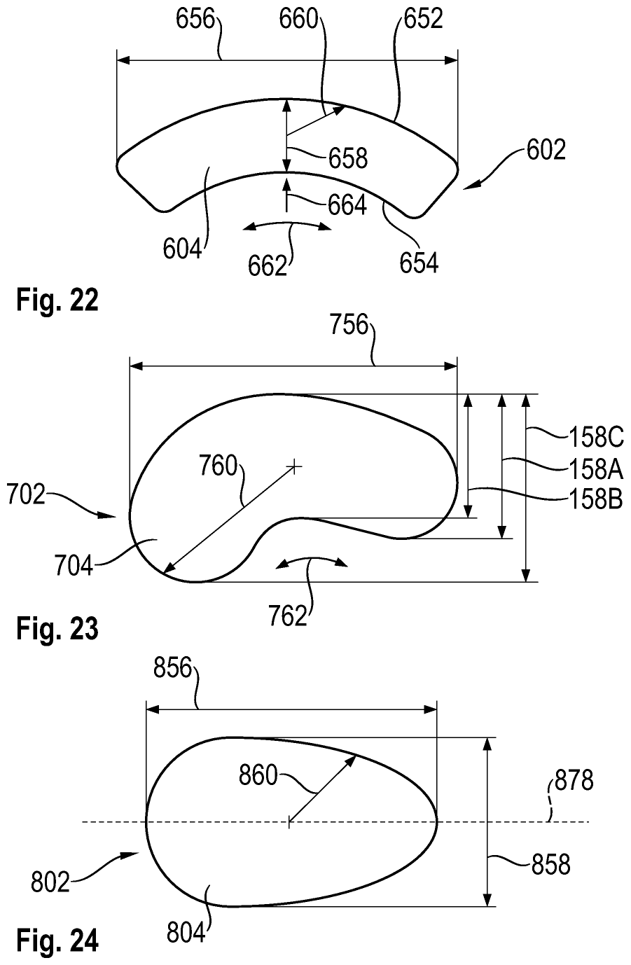

Referring now to FIG. 22, there is illustrated a brake piston, indicated generally at 602, and having a non-circular end face 604 in accordance with a sixth embodiment of the present invention. The brake piston 602 and the non-circular end face 604 are variations of the brake piston 102 and the non-circular end face 104 described with reference to FIGS. 1-12. As such, like reference numerals, increased by 500, designate corresponding parts in the drawings and detailed description thereof will be omitted, unless otherwise noted.

The non-circular end face 604 has a generally parabolic or arch shape. A first dimension 656 is a furthest extent of the non-circular end face 604 in a circumferential direction 662. A second dimension 658 is between first and second arcuate sides 694 and 696, respectively, of the non-circular end face 604. As illustrated, the second dimension 658, when parallel to a radial direction 664, is constant between the first and second arcuate sides 694 and 696, respectively. Alternatively, the second dimension 658 may be other than constant—i.e., it may be variable—between the first and second arcuate sides 694 and 696, respectively. The first dimension 656 is greater than the second dimension 658. The first and second dimensions 656 and 658 need not intersect at midpoints of each other.

Referring now to FIG. 23, there is illustrated a brake piston, indicated generally at 702, and having a non-circular end face 704 in accordance with a seventh embodiment of the present invention. The brake piston 702 and the non-circular end face 704 are variations of the brake piston 102 and the non-circular end face 104 described with reference to FIGS. 1-12. As such, like reference numerals, increased by 600, designate corresponding parts in the drawings and detailed description thereof will be omitted, unless otherwise noted.

The non-circular end face 704 has a kidney shape. The kidney shape of the non-circular end face 704 may be used such that the brake piston 702 better corresponds to a shape of a brake disc (not shown in FIG. 23). A first dimension 756 is to a furthest extent of the non-circular end face 704 in a direction tangential to a circumferential direction 762. Second, third, and fourth dimensions 758A, 758B, and 758C, respectively, are each perpendicular to the first dimension 756.

As illustrated, the first dimension 756 is greater than all of the second, third, and fourth dimensions 758A, 758B, and 758C, respectively. Alternatively, the first dimension 756 may be greater than between one and all of the second, third, and fourth dimensions 758A, 758B, and 758C. None of the first, second, third, or fourth dimensions 756, 758A, 758B, or 758C, respectively, need intersect midpoints of each other.

The second dimension 758A is greater than the third dimension 758B and less than the fourth dimension 758C. The third dimension 758B is less than both the second and fourth dimensions 758A and 758C, respectively. The fourth dimension 758C is greater than both the second and third dimensions 758A and 758B, respectively. The third dimension 758B is defined on the non-circular end face 704 between the second and fourth dimensions 758A and 758C, respectively.

Referring now to FIG. 24, there is illustrated a brake piston, indicated generally at 802, and having a non-circular end face 804 in accordance with an eighth embodiment of the present invention. The brake piston 802 and the non-circular end face 804 are variations of the brake piston 102 and the non-circular end face 104 described with reference to FIGS. 1-12. As such, like reference numerals, increased by 700, designate corresponding parts in the drawings and detailed description thereof will be omitted, unless otherwise noted.

The non-circular end face 804 has an egg shape with a single axis of symmetry 898. A first dimension 856 is greater than a second dimension 858, wherein the first and second dimensions 856 and 858, respectively, are perpendicular. The first and second dimensions 856 and 858, respectively, need not intersect at midpoints of each other.

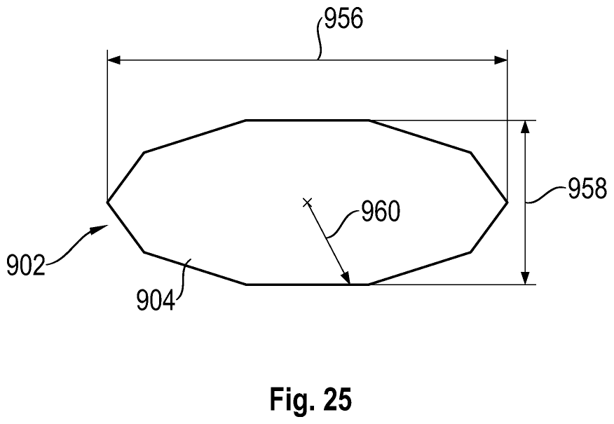

Referring now to FIG. 25, there is illustrated a brake piston, indicated generally at 902, and having a non-circular end face 904 in accordance with a ninth embodiment of the present invention. The brake piston 902 and the non-circular end face 904 are variations of the brake piston 102 and the non-circular end face 104 described with reference to FIGS. 1-12. As such, like reference numerals, increased by 800, designate corresponding parts in the drawings and detailed description thereof will be omitted, unless otherwise noted.

The non-circular end face 904 has a polygonal shape with linear edges. A first dimension 956 is greater than a second dimension 958, wherein the first and second dimensions 956 and 958, respectively, are perpendicular. The first and second dimensions 956 and 958 need not intersect at midpoints of each other.

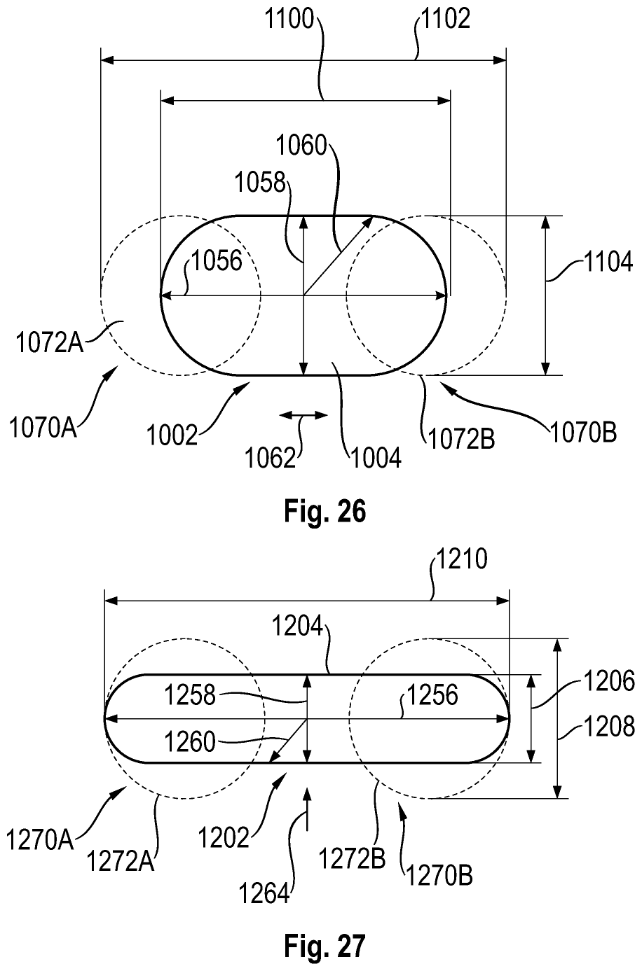

Referring now to FIG. 26, there is illustrated a brake piston, indicated generally at 1002, and having a non-circular end face 1004 in accordance with a tenth embodiment of the present invention. The brake piston 1002 and the non-circular end face 1004 are variations of the brake piston 102 and the non-circular end face 104 described with reference to FIGS. 1-12. As such, like reference numerals, increased by 900, designate corresponding parts in the drawings and detailed description thereof will be omitted, unless otherwise noted.

The non-circular end face 1004 has a first length 1100 in a direction tangential to a circumferential direction 1062. A second length 1102 is parallel to the first length 1100 and extends between combined furthest extents of first and second prior art circular end faces 1072A and 1072B, respectively. The first length 1100 is less than the second length 1102. Furthermore, the non-circular end face 1004, first prior art circular end face 1072A, and second prior art circular end face 1072B, respectively, all have a height 1104, wherein the height 1104 is perpendicular to the first length 1100.

Referring now to FIG. 27, there is illustrated a brake piston, indicated generally at 1202, and having a non-circular end face 1204 in accordance with an eleventh embodiment of the present invention. The brake piston 1202 and the non-circular end face 1204 are variations of the brake piston 102 and the non-circular end face 104 described with reference to FIGS. 1-12. As such, like reference numerals, increased by 1100, designate corresponding parts in the drawings and detailed description thereof will be omitted, unless otherwise noted.

The non-circular end face 1204 has a first height 1206 in a radial direction 1264. First and second prior art circular end faces 1272A and 1272B, respectively, each have a second height 1208 that is parallel to the first height 1206. The first height 1206 is less than the second height 1208. Furthermore, a length 1210 of the non-circular end face 1204 is equal a combined furthest extent of the first and second prior art circular end faces 1272A and 1272B, respectively, wherein the length 1210 is perpendicular to the first height 1206.

The brake pistons having the non-circular end faces discussed with reference to FIGS. 1-27 may be used with either the brake caliper 106, the alternate brake caliper 106′, or any other suitable brake caliper known to those skilled in the art.

The brake pistons discussed with reference to FIGS. 1-27 are not limited to the specific non-circular end face shapes illustrated in FIGS. 1-27. As such, the brake pistons may be provided with a non-circular end face that is different from those illustrated in FIGS. 1-27 or is a combination of features illustrated in FIGS. 1-27.

Furthermore, the brake pistons illustrated in FIGS. 1-27 with non-circular end faces have been discussed in conjunction with an EPB. Alternatively, the brake pistons illustrated in FIGS. 1-27 with non-circular end faces may be used in disc brake assemblies without an EPB or without any parking brake function.

In accordance with the provisions of the patent statutes, the principle and mode of operation of this invention have been described and illustrated in its preferred embodiments. However, it must be understood that this invention may be practiced otherwise than as specifically explained and illustrated without departing from its spirit or scope.

What is claimed is:

1. A brake piston for use in a disc brake assembly comprising:
an external surface disposed longitudinally; and
a non-circular end face being disposed perpendicular to the external surface and a longitudinal axis;
wherein the non-circular end-face and the external surface define a cavity and the non-circular end face is configured to engage with a brake disc when the disc brake assembly is actuated.

2. The brake piston as defined in claim 1 wherein the cavity is configured to receive a spindle nut within the cavity.

3. The brake piston as defined in claim 2 wherein the non-circular end face defines a variable radius.

4. The brake piston as defined in claim 3 wherein the non-circular end face has an elliptical shape.

5. The brake piston as defined in claim 4 wherein the non-circular end face defines a first dimension and a second dimension being perpendicular to the first dimension where the first dimension is greater than the second dimension.

6. The brake piston as defined in claim 5 wherein the first and second dimensions intersect at midpoints of each other.

7. The brake piston as defined in claim 6 wherein a ratio of the first and second dimensions is greater than 1.

8. The brake piston as defined in claim 6 wherein a ratio of the first and second dimensions is less than 1.

9. The brake piston as defined in claim 6 wherein the external surface, non-circular end face and the cavity are disposed within a brake shoe and a clearance is defined between the external surface and the brake shoe.

10. The brake piston as defined in claim 9 wherein the non-circular end face does not extend beyond the brake shoe.
